(19) United States
(12) Patent Application Publication
(10) Pub. No.: US 2023/0376175 A1
(43) Pub. Date: Nov. 23, 2023

(54) FACILITATING INTERACTIONS BASED ON USER ACCESS PATTERNS

(71) Applicant: Snap Inc., Santa Monica, CA (US)

(72) Inventors: Nathan Kenneth Boyd, Los Angeles, CA (US); David Phillip Taitz, Los Angeles, CA (US); Jue Zhou, New York, NY (US)

(21) Appl. No.: 18/320,010

(22) Filed: May 18, 2023

Related U.S. Application Data
(60) Provisional application No. 63/365,187, filed on May 23, 2022.

(51) Int. Cl. G06F 3/0482; G06F 3/04847; H04L 51/046; G06Q 50/00

(52) U.S. Cl. CPC G06F 3/0482; G06F 3/04847; H04L 51/046; G06Q 50/01

(57) ABSTRACT

In some examples, a technique according to the present disclosure includes detecting a determinable interaction pattern of interactions by a first user, via a user system, with a content item communicated on an interaction system by a second user. The determinable interaction pattern may comprise multiple access actions with respect to the content item by the first user. Responsive to detecting the determinable interaction pattern, an action graphical user interface element, that is user selectable to enable the first user to perform an action related to the content item, is automatically activated.

### CLAIM OF PRIORITY

This application claims the benefit of priority to U.S. Provisional Application Ser. No. 63/365,187, filed on May 23, 2022, which is incorporated herein by reference in its entirety.

### TECHNICAL FIELD

The present disclosure relates, generally, to electronic content sharing. More specifically, subject matter disclosed herein relates to systems and methods that facilitate user interactions based on determinable interaction patterns with content items.

### BACKGROUND

The popularity of computer-implemented programs that permit users to access and interact with content and other users online continues to grow. Various computer-implemented applications exist that permit users to share content with other users through interaction applications, e.g., messaging clients or content sharing clients. Some computer-implemented applications can be designed to run on a mobile device, such as a phone, a tablet, or a wearable device, while having a backend service provided on a server computer system to perform certain operations, e.g., those that may require resources greater than is reasonable to perform at a user device.

An interaction application, such as a messaging client executing at a user device, may enable a publishing user to capture a photo or video, and to share captured or viewed content to another device for viewing by a viewing user. The captured content may be augmented with items such as filters, media overlays, augmented reality effects, links, or the like. A viewing user may interact with the shared content, or with the publishing user, in various ways via the interaction application, e.g., by sending a reply message to the publishing user, or by capturing and sharing a further photo or video in response to the content shared by the publishing user.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a messaging system, according to some examples, that has both client-side and server-side functionality.

FIG. 3 is a flowchart illustrating a method to detect a determinable interaction pattern and activate an action graphical user interface element, according to some examples.

FIG. 4 is a flowchart illustrating a method to detect multiple access actions with respect to a content item forming part of a content collection, and activate an action graphical user interface element, according to some examples.

FIG. 5 is a user interface diagram illustrating a viewing user interface, according to some examples.

FIG. 6 is a user interface diagram illustrating a viewing user interface, according to some examples.

FIG. 7 is a user interface diagram illustrating the viewing user interface of FIG. 6, wherein an action graphical user interface element is presented in an adjusted display state, according to some examples.

FIG. 8 is a diagrammatic representation of a data structure as maintained in a database, according to some examples.

FIG. 9 is a diagrammatic representation of a message, according to some examples.

FIG. 10 is a diagrammatic representation of a system including a head-wearable apparatus, according to some examples.

FIG. 11 is a diagrammatic representation of a machine in the form of a computer system within which a set of instructions may be executed to cause the machine to perform any one or more of the methodologies discussed herein, according to some examples.

FIG. 12 is a block diagram showing a software architecture within which examples may be implemented.

### DETAILED DESCRIPTION

Within the context of an interaction system that allows users to share content, it is desirable to facilitate ease of communication of messages and content items between users. A number of technical challenges exist with respect to increasing the convenience and speed with which a user can consume content, and then interact with that content (e.g., by replying to a transmission or publication of an image or video posted by a user).

Viewing users often re-access content items, e.g., a user may re-watch a video, or revisit (or review) a digital photograph posted by another user of the interaction system (e.g., a friend of the viewing user). For example, where a content item is part of a navigable content collection including multiple other content items, the viewing user may navigate back to a particular content item to review it, or re-access the content collection on another occasion to review the particular content item. Such actions may be indicative of an interest, on the part of the viewing user, to interact with the particular content item or with a publishing user of that content item, making it desirable to facilitate ease of such an interaction.

Some examples described herein seek to provide various automations to remind a viewing user of, or direct a viewing user to, options for interacting with a content item (e.g., an image file, video file, audio file, or combinations thereof) that is accessed (e.g., viewed or listened to) multiple times by the viewing user.

In some examples, technical hurdles to increasing the ease or speed of communications between users of an interaction system are alleviated by providing a user interface enabling quick and easy replies to re-watched content items, e.g., re-watched items within content collections. Various forms of action graphical user interface elements, including, for example, reply elements, may be provided within such a user interface. Examples of the present disclosure also include various user interface element transitions to address or alleviate the aforementioned technical hurdles.

An action graphical user interface element may be used to provide a “reply hint” to a viewing user. For example, a quick reply tray may automatically be presented in response to detecting re-watching. In some examples, a reply interface element, such as a reply button or chat input field, may have its display state automatically adjusted (e.g., to visually distinguish the reply interface element from other interface elements, or from its own default state) in response to detecting re-watching. Activation of an action graphical user interface element and a display state change may be applied individually or in combination in examples of the present disclosure.

When the effects in this disclosure are considered in aggregate, one or more of the methodologies described herein may obviate a need for certain efforts or resources that otherwise would be involved in executing interaction applications. Computing resources used by one or more machines, databases, or networks may be more efficiently utilized or even reduced, e.g., as a result of automatic interface transitions (such as through presentation of automatic reminders or display state changes), or as a result of a reduced number of selections being required to achieve an effect. Examples of such computing resources may include processor cycles, network traffic, memory usage, graphics processing unit (GPU) resources, data storage capacity, power consumption, and cooling capacity.

Networked Computing Environment

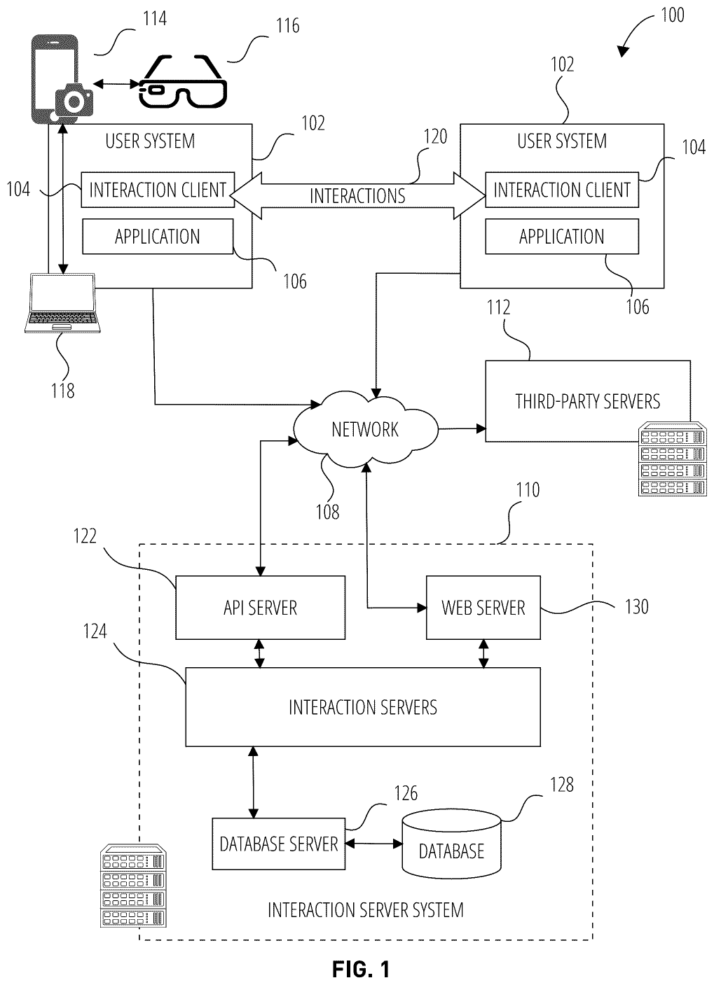

FIG. 1 is a block diagram showing an example interaction system 100 for facilitating interactions (e.g., exchanging text messages, conducting text audio and video calls, or playing games) over a network. The interaction system 100 includes multiple user systems 102, each of which hosts multiple applications, including an interaction client 104 (as an example of an interaction application) and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, social network information, and live event information. Data exchanges within the interaction system 100 are invoked and controlled through functions available via user interfaces (UIs) of the interaction clients 104.

Turning now specifically to the interaction server system 110, an API server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The API server 122 receives and transmits interaction data (e.g., commands and message payloads) between the interaction servers 124 and the user systems 102 (and, for example, interaction clients 104 and other application 106) and the third-party server 112. Specifically, the API server 122 provides a set of interfaces (e.g., routines and protocols) that can be called or queried by the interaction client 104 and other applications 106 to invoke functionality of the interaction servers 124. The API server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity graph (e.g., a social graph); the location of friends within a social graph; and opening an application event (e.g., relating to the interaction client 104).

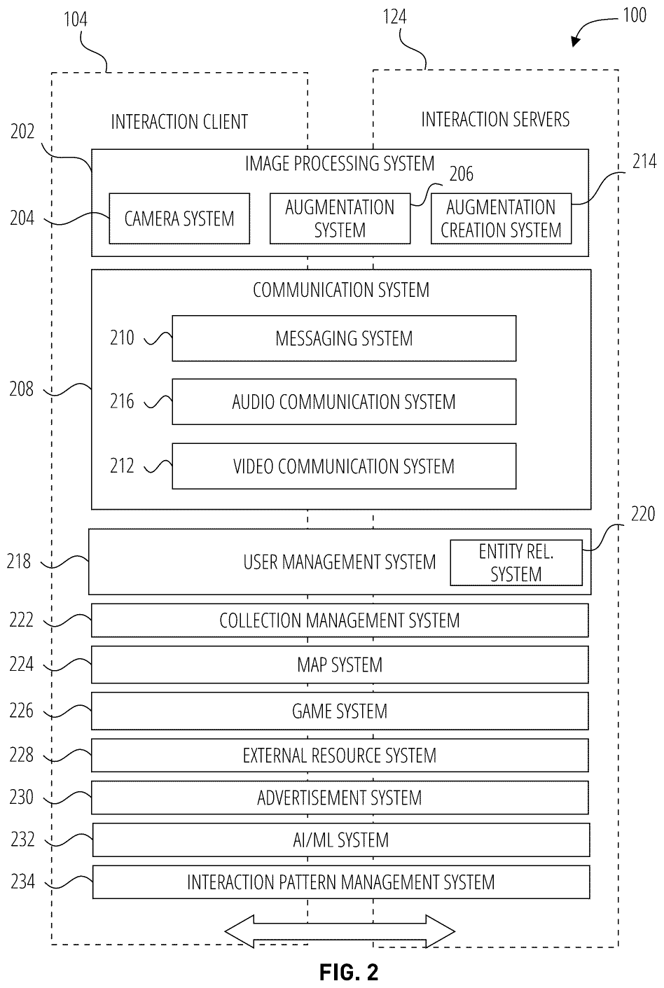

The interaction servers 124 host multiple systems and subsystems, described below with reference to FIG. 2.

Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally-installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally-installed application 106, the interaction client 104 instructs the user system 102 to launch the external resource by executing locally-stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of microservice subsystems may include:

Function logic: The function logic implements the functionality of the microservice subsystem, representing a specific capability or function that the microservice provides. API interface: Microservices may communicate with each other components through well-defined APIs or interfaces, using lightweight protocols such as REST or messaging. The API interface defines the inputs and outputs of the microservice subsystem and how it interacts with other microservice subsystems of the interaction system 100.

Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.

Service discovery: Microservice subsystems may find and communicate with other microservice subsystems of the interaction system 100. Service discovery mechanisms enable microservice subsystems to locate and communicate with other microservice subsystems in a scalable and efficient way.

Monitoring and logging: Microservice subsystems may need to be monitored and logged in order to ensure availability and performance. Monitoring and logging mechanisms enable the tracking of health and performance of a microservice subsystem.

Example subsystems are discussed below. Firstly, and still referring to FIG. 2, an image processing system 202 provides various functions that enable a user to capture and augment (e.g., annotate or otherwise modify or edit) media content associated with a message.

A camera system 204 includes control software (e.g., in a camera application) that interacts with and controls hardware camera hardware (e.g., directly or via operating system controls) of the user system 102 to modify and augment real-time images captured and displayed via the interaction client 104.

An augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory of a user system 102. These augmentations are selected by the augmentation system 206 and presented to a user of an interaction client 104, based on a number of inputs and data, such as for example:
Geolocation of the user system 102; and
Social network information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and includes an entity relationship system 220 that maintains information regarding relationships between users of the interaction system 100.

A collection management system 222 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 222 may also be responsible for publishing an icon that provides notification of a particular collection to the user interface of the interaction client 104. The collection management system 222 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 222 employs machine vision (or image recognition technology) and content rules to curate a content collection automatically. In certain examples, compensation may be paid to a user to include user-generated content into a collection. In such cases, the collection management system 222 operates to automatically make payments to such users to use their content.

A map system 224 provides various geographic location functions and supports the presentation of map-based media content and messages by the interaction client 104. For example, the map system 224 enables the display of user icons or avatars (e.g., stored in profile data 802) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 226 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 228 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A Web ViewJavaScriptBridge running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 230 operationally enables the purchasing of advertisements by third parties for presentation to end-users via the interaction clients 104 and also handles the delivery and presentation of these advertisements.

Various functions or features of the interaction system 100 may incorporate, or use, artificial intelligence (AI) and machine learning (ML). The interaction system 100 may thus include an AI/ML system 232. For example, the AI/ML system 232 operates with the image processing system 202 and the camera system 204 to analyze images and extract information such as objects, text, or faces. This information can then be used by the image processing system 202 to enhance, filter, or manipulate images. The AI/ML system 232 may be used by the augmentation system 206 to generate augmented content and augmented reality experiences, such as adding virtual objects or animations to real-world images. The communication system 208 and messaging system 210 may use the AI/ML system 232 to analyze communication patterns and provide insights into how users interact with each other and provide intelligent message classification and tagging, such as categorizing messages based on sentiment or topic. The AI/ML system 232 may also provide chatbot functionality to message interactions 120 between user systems 102 and between a user system 102 and the interaction server system 110. The AI/ML system 232 may also work with the audio communication system 216 to provide speech recognition and natural language processing capabilities, allowing users to interact with the interaction system 100 using voice commands.

An interaction pattern management system 234 forms part of the interaction system 100, in some examples. The interaction pattern management system 234 is responsible for detecting determinable interaction patterns by users of the interaction system 100, and initiating predefined responses based on respective determinable interaction patterns. For example, and as described further below, the interaction pattern management system 234 may work with the messaging system 210 or the collection management system 222 to identify that a user has accessed a content item multiple times and, in response thereto, cause activation, presentation and/or highlighting of a specific action graphical user interface element to enable the user to perform an action related to the content item (or to facilitate the performance of such an action). In some examples, the interaction pattern management system 234 may communicate with the AI/ML system 232 to apply machine learning techniques in respect of the detection of, or response to, determinable interaction patterns relating to content items within the interaction system 100.

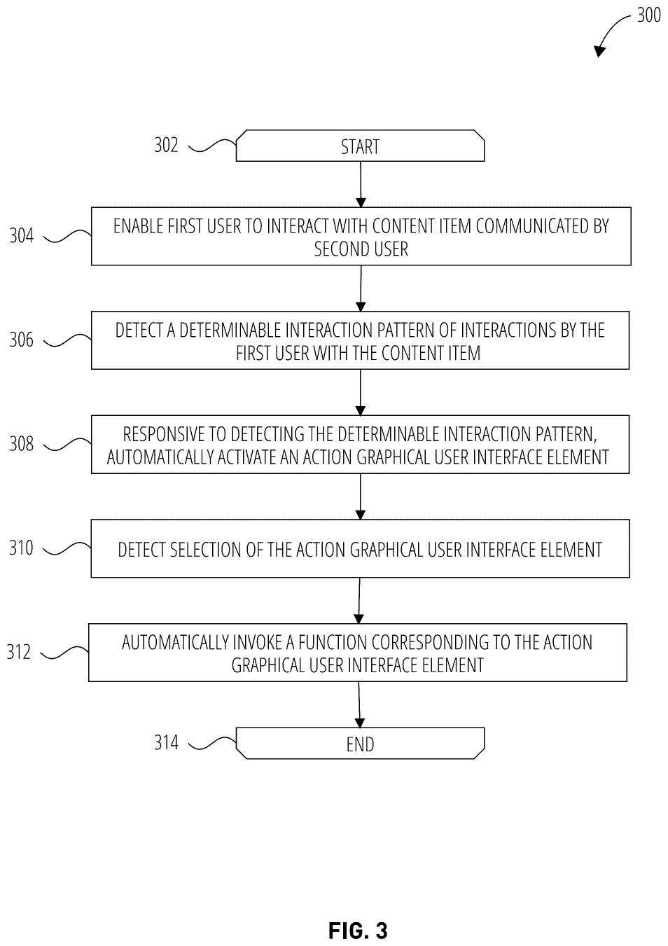

FIG. 3 is a flowchart illustrating a method 300, according to some examples, to enable a user of the interaction system 100 to perform an action (e.g., reply to another user) related to a content item (e.g., an image or video) posted by the other user via the interaction system 100. For ease of reference, the user viewing the content item and enabled to perform the action is referred to as the “viewing user,” and the user responsible for communicating (e.g., sending, sharing, or posting) the content item for viewing by the viewing user is referred to as the “publishing user.” The method 300 is performed, in some examples, by various subsystems of the interaction system 100, e.g., the messaging system 210, the collection management system 222, or the interaction pattern management system 234.

The method 300 commences at opening loop element 302, and then progresses to operation 304, where the interaction system 100 enables a first user (e.g., the viewing user) to interact with a content item communicated by a second user (e.g., the publishing user) via the interaction system 100. Both users use an interaction client 104 to participate in the interaction system 100. The content item may include different forms of user input content, e.g., image, video, text or audio content, or combinations thereof. For example, the content item may include image data stored within the image table 804 or video data stored within the video table 806. In some examples, the user input content includes augmentations, such as media overlays or filters. A publishing user may, for example, use a camera function of the interaction client 104 to capture a content item (and apply an augmentation, if desired), or may load a previously captured or stored content item from a storage location, e.g., a media library of the user system 102.

The content item may be part of a set or collection of content items that are published by the publishing user within the interaction system 100, either to a feed (e.g., a “story”) managed by the collection management system 222, or by a messaging function provided by the messaging system 210. In some cases, the viewing user can navigate between items in the collection by performing predefined actions, such as tapping gestures in predefined navigation zones of a viewing user interface. In some examples, the collection may display each content item for a predefined time period before automatically proceeding to present the next content item in the collection (unless the user provides contrary user input during the predefined time period, such as tapping to advance to the next content item, or pausing presentation at a specific content item).

At operation 306 of the method 300, the interaction client 104 executing on a user device of the viewing user, e.g., on a suitable user system 102, detects a determinable interaction pattern of interactions, by the viewing user, with respect to (or related to) the content item published via the interaction system 100 to the interaction client 104 of the viewing user. The interaction pattern management system 234 may be configured to check recorded interactions, by the viewing user, with each content item within the interaction system 100.

The determinable interaction pattern may comprise a series of access actions, e.g., performed within a determinable time (such as, for example, 24 hours, 48 hours, or one week), with respect to a content item published on the interaction system 100 by a publishing user. For example, where the content item is an image or video, the interaction client 104 may detect that the viewing user performs multiple viewings (e.g., re-watches or re-views) of the relevant image or video using the interaction client 104. Where the content item is an audio file, the interaction client 104 may similarly detect that the viewing user listens (e.g., re-listens) to the audio file using the interaction client 104. The interaction pattern management system 234 may, for example, when the viewing user accesses a content item, perform a check within the database 128 to determine whether the viewing user has accessed the particular content item before. If the interaction pattern management system 234 determines that the content item has indeed been accessed before, the interaction pattern management system 234 may trigger an automatic function of the interaction system 100 to facilitate user interactions, as described further with reference to operation 308.

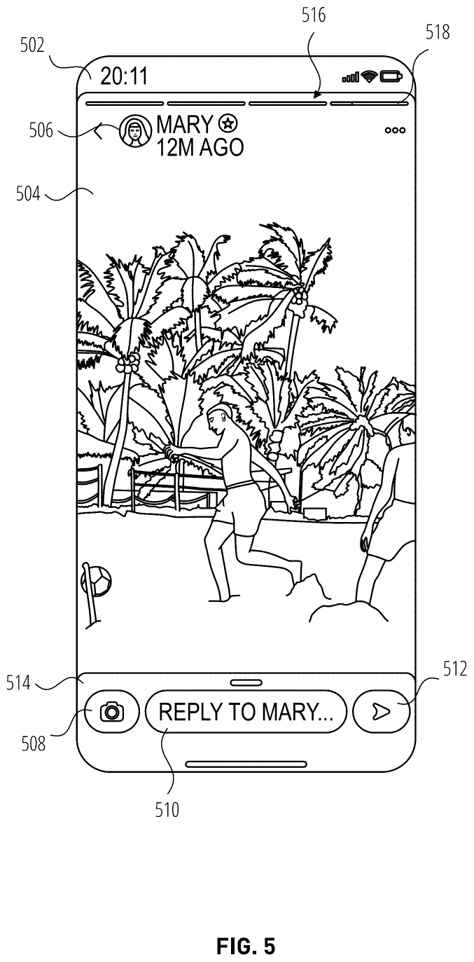

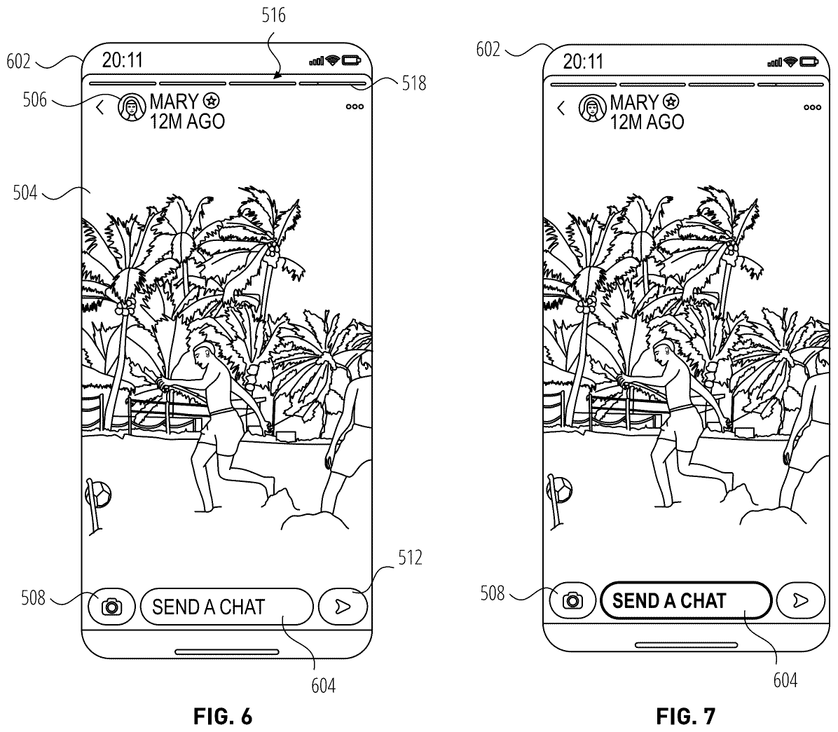

At operation 308, the interaction client 104, responsive to detecting the determinable interaction pattern, automatically activates an action graphical user interface element. The action graphical user interface element is user selectable to enable the viewing user to perform an action related to the content item. For example, the interaction pattern management system 234 may detect a specific determinable interaction pattern, corresponding to a determinable interaction pattern for which a corresponding function is recorded within the interaction system 100. The action graphical user interface element may be a reply button that is presented and activated within a viewing user interface by the messaging system 210 in response to the detection of the interaction pattern. In some examples, multiple action graphical user interface elements, or a set of interaction elements, are activated or presented within the viewing user interface. Examples of such elements are shown in FIG. 5, FIG. 6, and FIG. 7, and described further below.

At operation 310, the interaction client 104 may detect a selection of the action graphical user interface element within the viewing user interface. In response, the interaction client 104 may automatically invoke a function of the interaction system 100 to enable the viewing user to perform a specific action, or actions, related to the content item (operation 312). For example, a reply function provided by the messaging system 210 may be activated by the interaction client 104 to enable the viewing user to reply to the publishing user regarding the content item 504 (FIG. 5). A messaging function provided by the messaging system 210 may also (or alternatively) be activated by the interaction client 104 to enable the viewing user to generate and transmit a message to the publishing user about the content item 504. Other actions enabled by the invoked function may include, for example, sharing the content item to a third-party user or platform, reacting to the content item (e.g., “liking” the content item electronically), or publishing a comment about the content item. The method 300 terminates at closing loop element 314.

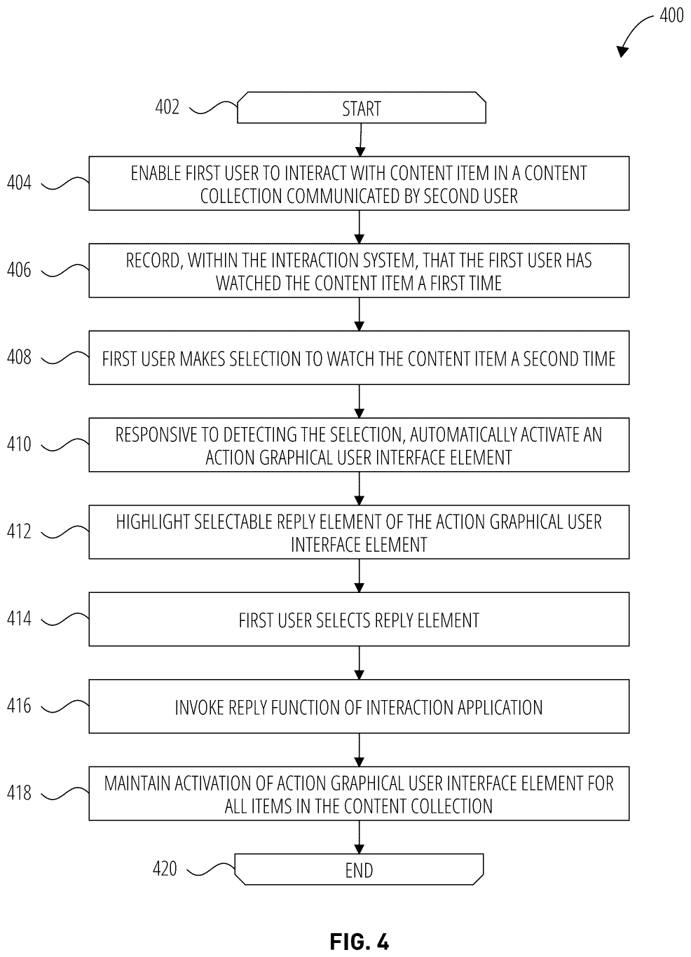

FIG. 4 is a flowchart illustrating a method 400, according to some examples, to detect multiple access actions with respect to a content item forming part of a content collection, and activate an action graphical user interface element. The method 400 is performed, in some examples, by the various subsystems of the interaction system 100, e.g., the messaging system 210, the collection management system 222, or the interaction pattern management system 234.

The method 400 is described with reference to examples of viewing user interfaces depicted in FIG. 5, FIG. 6, and FIG. 7, which may be presented to a viewing user by the interaction client 104 (as an example of an interaction application). Viewing user interfaces, such as those depicted in FIG. 5, FIG. 6, and FIG. 7, may be presented by an interaction client 104 executing on a device such as the mobile device 114.

It is noted that while interfaces in FIG. 5, FIG. 6, and FIG. 7, are described and shown as being presented on a touch screen, such as a screen of the mobile device 114, interfaces according to some examples may also be presented using other types of devices that can provide suitable user interfaces or displays, e.g., the optical display of a head-wearable apparatus 116, a desktop computer, or via smart contact lenses. Examples of the present disclosure are thus not restricted to user interfaces that require touch-based gestures.

The method 400 commences at opening loop element 402, and then progresses to operation 404, where the interaction system 100 enables a first user (e.g., the viewing user) to interact with a content item communicated by a second user (e.g., the publishing user) via the interaction system 100.

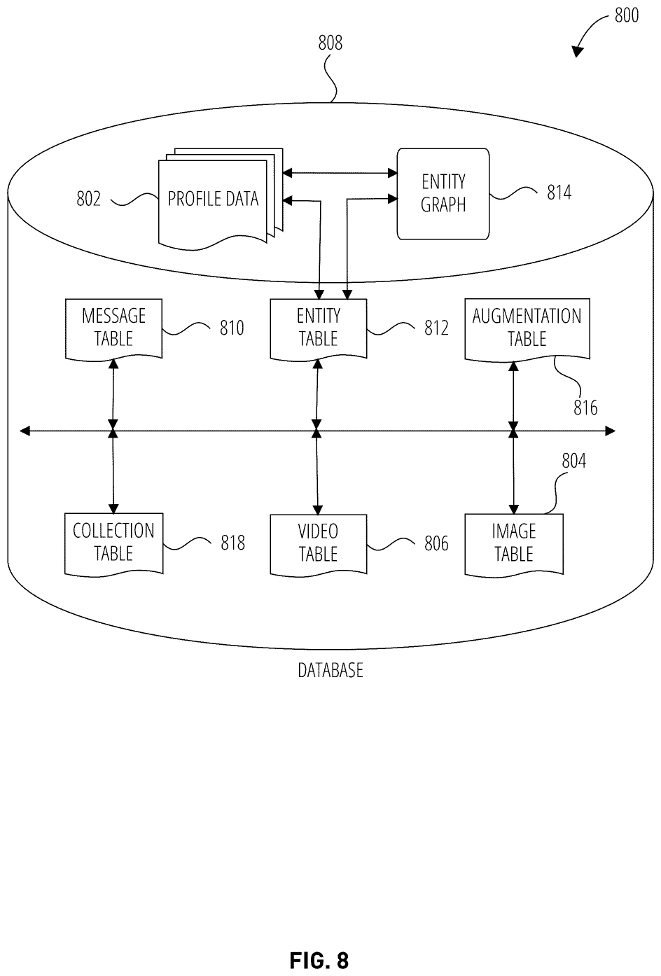

At operation 406, the viewing user accesses the content item for a first time, e.g., accesses a content collection and views a specific item therein for the first time, which is detected by the interaction system 100 (e.g., the interaction pattern management system 234 or collection management system 222) and a record of the accessing of the content item is stored within the interaction system 100, e.g., in a database, such as the database 128 or the database 808. For example, interaction history may be stored as part of profile data 802, as described with reference to FIG. 8 below.

Then, at operation 408, the same viewing user makes a selection to access the same content item again. As mentioned above, the viewing user may navigate back to the content item where the content item is part of a collection, or may re-access the content item in a different way, such as re-opening the interaction client 104, searching for the publishing user's profile, and accessing the profile to view the same content item again.

FIG. 5 shows a viewing user interface 502, according to some examples, within which an active content item 504 is displayed for viewing by the viewing user. Here, the content item 504 is a video that forms part of a collection of content items (e.g., a “story”) published by a publishing user (“Mary”), who is identified by user identification information 506 within the viewing user interface 502. A set indicator 516 identifies the content item 504 as being part of a collection that is being automatically played (or replayed, when re-watching occurs) in a sequence, and the playing (or re-playing) position of the content item 504 is indicated by an active content item identifier 518 that is continuously updated so as to function as a progress bar.

In some examples, the set of content items (collection) is published by the interaction system 100 as a feed associated with the publishing user (“Mary”), and the feed is accessible to the viewing user on account of relationship information maintained by the interaction system 100 indicating a relationship between the first user and the second user. For example, the interaction system 100 may store, within an entity table 812 or an entity graph 814, data indicating the relationship that has been established, e.g., a bidirectional (“friend”) relationship, or a one-directional relationship in which the viewing user follows, or subscribes to, posts made by the publishing user, but not vice versa. In some examples, the interaction pattern management system 234 or the collection management system 222 only allows activation of the action graphical user interface elements as described herein when a predefined type of relationship exists between the two users, e.g., a bidirectional relationship.

The interaction client 104, e.g., using the interaction pattern management system 234, may detect that the viewing user is re-watching the video within the viewing user interface 502 or has made a selection to re-watch the video. Responsive to detection of the second viewing of the content item 504, the interaction client 104 activates an action graphical user interface element (operation 410). Examples of action graphical user interface elements are shown in FIG. 5, FIG. 6, and FIG. 7, as will be described below.

Multiple action graphical user interface elements, or an action graphical user interface element with multiple sub-elements, may be presented within viewing user interfaces in examples of the present disclosure. For example, and as shown in FIG. 5, the action graphical user interface element may include a camera button 508 and a text input field 510 that are activated within the viewing user interface 502 to enable the viewing user to conveniently reply to the publishing user, or send a chat message to the publishing user, related to the content item 504.

In some examples, a quick reply tray 514, including the camera button 508, text input field 510 and a send to button 512 (described below), may be automatically presented within the viewing user interface 502 as the viewing user re-watches the content item 504.

In some examples, there may be a delay between presentation of the re-accessed content item 504 and presentation of the action graphical user interface element, e.g., the reply tray 514. For example, the viewing user may commence re-watching the content item 504 and the interaction pattern management system 234 detects the re-watching. If re-watching continues for a predefined period, e.g., 1 second or 2 seconds, the reply tray 514 is automatically activated and presented within the viewing user interface 502. In some examples, the action graphical user interface element may thus transition into, or appear to animate into, the viewing user interface 502, as the viewing user is re-watching or re-viewing (or re-listening, in examples that include audio) the relevant content item.

In some examples, the reply tray 514 may be manually closed by the viewing user performing a predefined closing action, e.g., a swipe-down action with respect to the reply tray 514.

The camera button 508 is user selectable to invoke a reply state facilitated by a reply camera interface, as described below. The text input field 510 (or a chat input field 604, as shown in FIG. 6) enables the viewing user to generate text of a message and transition to a messaging state. The messaging state may cause presentation of a keyboard or other user input elements to allow the viewing user to generate and send a reply message. The text added to the text input field 510 may thus accompany a reply transmission to the publishing user. The send to button 512, also referred to as a share button, can be selected by the user to share the content item 504, e.g., with a third-party user, as a direct message to a publishing user together with comments, to the viewing user's own “story,” or to a third-party messaging application.

Referring now to the viewing user interface 602 in FIG. 6, in some examples, a camera button 508, chat input field 604, and send to button 512 are not part of a reply tray and may persist within the viewing user interface 602 during a re-watch of the content item 504. The camera button 508, chat input field 604 and send to button 512 of FIG. 6 are presented as overlaid on the content item 504.

It will be evident from the descriptions above that, in some examples, the action graphical user interface element is absent from the viewing user interface when the viewing user accesses or views the content item the first time, and only surfaces when the viewing user accesses or views the content item the second time (or another predetermined time, depending on the settings of the interaction pattern management system 234). Thus, the reply elements, such as the camera button 508 or the text input field 510, are, in some examples, only presented during re-watching or re-accessing of the content item 504. As such, the viewing user interface 502 may be devoid of the reply tray 514 when the viewing user first accesses the content item. When accessing the content item the first time, additional selections may thus be required to access the reply tray 514. For instance, the viewing user would need to perform a swiping gesture to open the reply tray 514 during the first viewing.

It will further be evident from the descriptions above that, in some examples, the action graphical user interface element is already presented when the viewing user accesses or views the content item the first time and persists in subsequent views, but with activation thereof causing certain changes.

Activation of the action graphical user interface element when the viewing user accesses or views the content item the second time (or another predetermined time) may cause display state changes within the action graphical user interface element, or parts thereof. For example, the action graphical user interface element may be visually highlighted (e.g., by displaying it, or parts thereof, in a particular color) or otherwise placed in a specific display state during re-watching of the content item 504.

In some examples, the action graphical user interface element may both appear in the viewing user interface for the first time upon re-watching and be visually highlighted, or undergo a display state change, to emphasize the availability of the action graphical user interface element upon re-watching.

Turning again to the method 400 of FIG. 4 and the viewing user interface 502 of FIG. 5, at operation 412, the camera button 508 (as an example of a reply element of an action graphical user interface element) is highlighted. For example, the camera button 508 may be displayed in a different color during a re-watching of a content item 504, e.g., as opposed to the color of the camera button 508 during an initial viewing of the content item 504, or as opposed to the color of other elements in the reply tray 514.

In some examples, when the content item 504 is being re-watched, there is a delay between presentation of the action graphical user interface element (e.g., reply element) and its display state change. For example, the camera button 508 may be presented as a white camera image against a gray or black background initially, and in response to the viewing user continuing with the re-watching of the content item 504 for a predefined period, e.g., 1 second or 2 seconds, the interaction client 104 may automatically adjust the camera button 508 such that it undergoes a display state transition, e.g., with the white image changing to a yellow color. As another example, and as is conceptually illustrated through highlighting/thickening of the borders and text of the chat input field 604 in FIG. 7 relative to FIG. 6, the chat input field 604 may be displayed in a different color, or otherwise highlighted or distinguished, when compared to the appearance of the chat input field 604 in FIG. 6.

In some examples, a display state of the action graphical user interface element, or sub-elements or parts thereof, may vary depending on the number of accesses (e.g., viewings or watchings) of a particular content item. In FIG. 5, as an example, the interaction client 104 may adjust the display state of the action graphical user interface element based on a number of times the content item 504 has been accessed. In some examples, the camera button 508 or another reply element may be overlaid with a graphical numerical indication of the number of times that the relevant content item 504 has been re-watched, or may have a border zone that becomes progressively thicker or larger each time the content item 504 is re-watched, or may have a color that changes based on the number of times that the relevant content item 504 has been re-watched. The colors, borders, or other visual elements may escalate in brightness, intensity, or other property based on the number of re-watches.

As mentioned, in some examples, the action graphical user interface elements are reply elements that are user selectable to invoke a reply function of the interaction client 104. Activation or presentation of such a reply element may thus be designed to provide the viewing user with a “reply hint,” facilitating interactions between users within the interaction system 100 (e.g., improving speed or ease of interactions by requiring fewer manual selections), and encouraging users to communicate and share creative content (e.g., through a reply camera function). In some examples, multiple reply hints may be surfaced at the same time, or at different times. For example, and referring to FIG. 7, while the chat input field 604 may undergo a display state transition to provide a reply hint as described above, the camera button 508 may also undergo a display state transition to provide an additional reply hint within the same viewing user interface 602. These activations, or transitions, need not necessarily occur at the same time.

Returning to FIG. 4, at operation 414, the viewing user chooses to select the camera button 508, which causes the interaction client 104 to invoke a reply function (operation 416), e.g., a modular reply camera function. A reply camera function may cause the presentation of a reply interface allowing the user to generate a user input content item by taking a picture (e.g., using a front-facing camera of a mobile device 114 hosting the interaction client 104) and sending that picture to a third-party user (e.g., the publishing user).

In some examples, activation of the action graphical user interface element for one content item may be linked to other content items in the same collection. The collection management system 222 may record the activation of the action graphical user interface element and apply the relevant features across all such content items. This may be recorded in profile data 802, or in an entity table 812, for example, as described with reference to FIG. 8 below.

Referring again to FIG. 5, once the reply tray 514 is presented, activated, or open, for any of a number of content items included within a collection of content items (e.g., a “story”), the reply tray 514 may remain open and displayed for the display of any other content items of the relevant collection. Similarly, if a reply element has undergone an automatic display state change, such as a color change, the change may persist throughout the content collection. The interaction system 100 may thus maintain the activation of the action graphical user interface element for all items in the content collection, once triggered, at operation 418.

Note, for example, in the viewing user interface 502, that the set indicator 516 identifies the content item 504 as being part of a collection that is being automatically played in a sequence. As the activation only applies to the specific content collection, the reply tray 514 may be closed (e.g., no longer displayed within the viewing user interface 502) when the viewing user accesses and views a further, different collection of content items, unless the first collection of content items is also being re-watched, or unless activation of a similar action graphical user interface element has already been triggered for the further collection. The method 400 concludes at closing loop element 420.

Data Architecture

FIG. 8 is a schematic diagram illustrating data structures 800, which may be stored in a database 808 of the interaction server system 110, according to certain examples. While the content of the database 808 is shown to comprise multiple tables, it will be appreciated that the data could be stored in other types of data structures (e.g., as an object-oriented database).

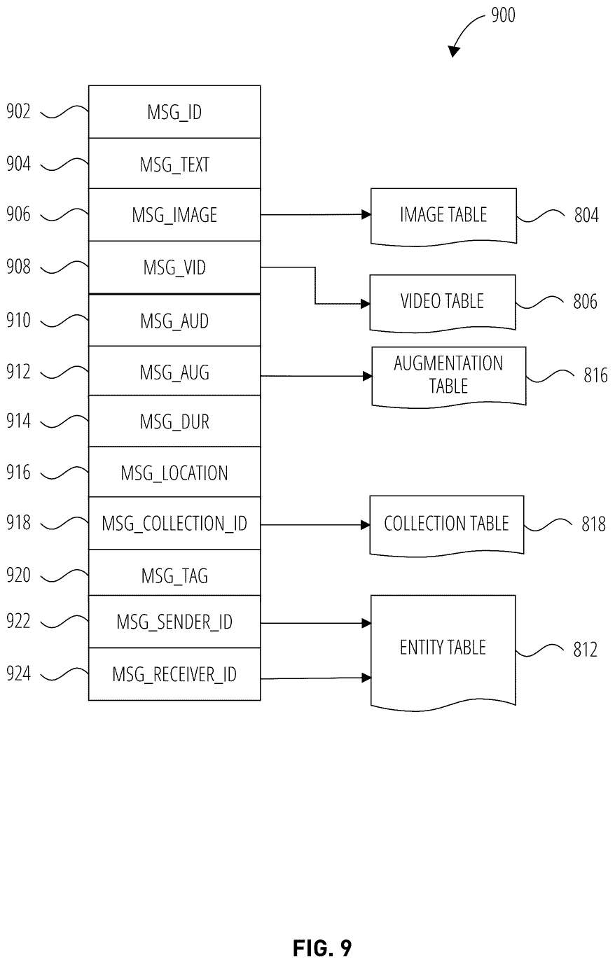

The database 808 includes message data stored within a message table 810. This message data includes, for any particular message, at least message sender data, message recipient (or receiver) data, and a payload. Further details regarding information that may be included in a message, and included within the message data stored in the message table 810, are described below with reference to FIG. 9.

An entity table 812 stores entity data, and is linked (e.g., referentially) to an entity graph 814 and profile data 802. Entities for which records are maintained within the entity table 812 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 814 stores information regarding relationships and associations between entities. Such relationships may be social, professional (e.g., work at a common corporation or organization), interest-based, or activity-based, merely for example.

The profile data 802 stores multiple types of profile data about a particular entity. The profile data 802 may be selectively used and presented to other users of the interaction system 100 based on privacy settings specified by a particular entity. Where the entity is an individual, the profile data 802 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 802 for the group may similarly include one or more avatar representations associated with the group, in addition to the group name, members, and various settings (e.g., notifications) for the relevant group.

As mentioned above, profile data 802 may include, for a viewing user, interaction history information regarding previous interactions with content items. For example, an interaction pattern management system 234 may utilize the profile data 802 to detect a determinable interaction pattern of the viewing user with a particular content item, to enable a predefined function of the interaction system 100 to be invoked responsive thereto.

The database 808 also stores augmentation data, such as overlays or filters, in an augmentation table 816. The augmentation data is associated with and applied to videos (for which data is stored in a video table 806) and images (for which data is stored in an image table 804).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 804 includes augmented reality content items (e.g., corresponding to applying Lenses or augmented reality experiences). An augmented reality content item may be a real-time special effect and sound that may be added to an image or a video.

As described above, augmentation data includes augmented reality (AR), virtual reality (VR) and mixed reality (MR) content items, overlays, image transformations, images, and modifications that may be applied to image data (e.g., videos or images). This includes real-time modifications, which modify an image as it is captured using device sensors (e.g., one or multiple cameras) of the user system 102 and then displayed on a screen of the user system 102 with the modifications. This also includes modifications to stored content, such as video clips in a collection or group that may be modified. For example, in a user system 102 with access to multiple augmented reality content items, a user can use a single video clip with multiple augmented reality content items to see how the different augmented reality content items will modify the stored clip. Similarly, real-time video capture may use modifications to show how video images currently being captured by sensors of a user system 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudorandom animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects, and using transformations and animated textures of the model within the video to achieve the transformation. In some examples, tracking of points on an object may be used to place an image or texture (which may be two-dimensional or three-dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device, or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of an object's elements, characteristic points for each element of an object are calculated (e.g., using an Active Shape Model (ASM) or other known methods). Then, a mesh based on the characteristic points is generated for each element of the object. This mesh is used in the following stage of tracking the elements of the object in the video stream. In the process of tracking, the mesh for each element is aligned with a position of each element. Then, additional points are generated on the mesh.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification, properties of the mentioned areas can be transformed in different ways. Such modifications may involve changing the color of areas; removing some part of areas from the frames of the video stream; including new objects into areas that are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation.

In some examples of a computer animation model to transform image data using face detection, the face is detected on an image using a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

A transformation system can capture an image or video stream on a client device (e.g., the user system 102) and perform complex image manipulations locally on the user system 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the user system 102.

In some examples, a computer animation model to transform image data can be used by a system where a user may capture an image or video stream of the user (e.g., a selfie) using the user system 102 having a neural network operating as part of an interaction client 104 operating on the user system 102. The transformation system operating within the interaction client 104 determines the presence of a face within the image or video stream and provides modification icons associated with a computer animation model to transform image data, or the computer animation model can be present as associated with an interface described herein. The modification icons include changes that are the basis for modifying the user's face within the image or video stream as part of the modification operation. Once a modification icon is selected, the transform system initiates a process to convert the image of the user to reflect the selected modification icon (e.g., generate a smiling face on the user). A modified image or video stream may be presented in a graphical user interface displayed on the user system 102 as soon as the image or video stream is captured and a specified modification is selected. The transformation system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

The graphical user interface, presenting the modification performed by the transform system, may supply the user with additional interaction options. Such options may be based on the interface used to initiate the content capture and selection of a particular computer animation model (e.g., initiation from a content creator user interface). In various examples, a modification may be persistent after an initial selection of a modification icon. The user may toggle the modification on or off by tapping or otherwise selecting the face being modified by the transformation system and store it for later viewing or browsing to other areas of the imaging application. Where multiple faces are modified by the transformation system, the user may toggle the modification on or off globally by tapping or selecting a single face modified and displayed within a graphical user interface. In some examples, individual faces, among a group of multiple faces, may be individually modified, or such modifications may be individually toggled by tapping or selecting the individual face or a series of individual faces displayed within the graphical user interface.

A collection table 818 stores data regarding collections of messages and associated image, video, or audio data, which are compiled into a collection (e.g., a story or a gallery). The creation of a particular collection may be initiated by a particular user (e.g., each user for which a record is maintained in the entity table 812). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may require a second degree of authentication to verify that the end-user belongs to a specific organization or other entity (e.g., is a student on the university campus).

As mentioned above, the video table 806 stores video data that, in some examples, is associated with messages for which records are maintained within the message table 810. Similarly, the image table 804 stores image data associated with messages for which message data is stored in the entity table 812. The entity table 812 may associate various augmentations from the augmentation table 816 with various images and videos stored in the image table 804 and the video table 806.

Data Communications Architecture

FIG. 9 is a schematic diagram illustrating a structure of a message 900, according to some examples, generated by an interaction client 104 for communication to a further interaction client 104 via the interaction servers 124. The content of a particular message 900 is used to populate the message table 810 stored within the database 808, accessible by the interaction servers 124. Similarly, the content of a message 900 is stored in memory as “in-transit” or “in-flight” data of the user system 102 or the interaction servers 124. A message 900 is shown to include the following example components: Message identifier 902: a unique identifier that identifies the message 900.
Message text payload 904: text, to be generated by a user via a user interface of the user system 102, and that is included in the message 900.
Message image payload 906: image data, captured by a camera component of a user system 102 or retrieved from a memory component of a user system 102, and that is included in the message 900. Image data for a sent or received message 900 may be stored in the image table 804.
Message video payload 908: video data, captured by a camera component or retrieved from a memory component of the user system 102, and that is included in the message 900. Video data for a sent or received message 900 may be stored in the video table 806.
Message audio payload 910: audio data, captured by a microphone or retrieved from a memory component of the user system 102, and that is included in the message 900.
Message augmentation data 912: augmentation data (e.g., filters, stickers, or other annotations or enhancements) that represents augmentations to be applied to message image payload 906, message video payload 908, or message audio payload 910 of the message 900. Augmentation data for a sent or received message 900 may be stored in the augmentation table 816.
Message duration parameter 914: parameter value indicating, in seconds, the amount of time for which content of the message (e.g., the message image payload 906, message video payload 908, message audio payload 910) is to be presented or made accessible to a user via the interaction client 104.
Message geolocation parameter 916: geolocation data (e.g., latitudinal and longitudinal coordinates) associated with the content payload of the message. Multiple message geolocation parameter 916 values may be included in the payload, each of these parameter values being associated with respect to content items included in the content (e.g., a specific image within the message image payload 906, or a specific video in the message video payload 908).
Message collection identifier 918: identifier values identifying one or more content collections (e.g., “stories” identified in the collection table 818) with which a particular content item in the message image payload 906 of the message 900 is associated. For example, multiple images within the message image payload 906 may each be associated with multiple content collections using identifier values.
Message tag 920: each message 900 may be tagged with multiple tags, each of which is indicative of the subject matter of content included in the message payload. For example, where a particular image included in the message image payload 906 depicts an animal (e.g., a lion), a tag value may be included within the message tag 920 that is indicative of the relevant animal. Tag values may be generated manually, based on user input, or may be automatically generated using, for example, image recognition.
Message sender identifier 922: an identifier (e.g., a messaging system identifier, email address, or device identifier) indicative of a user of the user system 102 on which the message 900 was generated and from which the message 900 was sent.
Message receiver identifier 924: an identifier (e.g., a messaging system identifier, email address, or device identifier) indicative of a user of the user system 102 to which the message 900 is addressed.

The contents (e.g., values) of the various components of message 900 may be pointers to locations in tables within which content data values are stored. For example, an image value in the message image payload 906 may be a pointer to (or address of) a location within an image table 804. Similarly, values within the message video payload 908 may point to data stored within a video table 806, values stored within the message augmentation data may point to data stored in an augmentation table 816, values stored within the message collection identifier 918 may point to data stored in a collection table 818, and values stored within the message sender identifier 922 and the message receiver identifier 924 may point to user records stored within an entity table 812.

System with Head-Wearable Apparatus

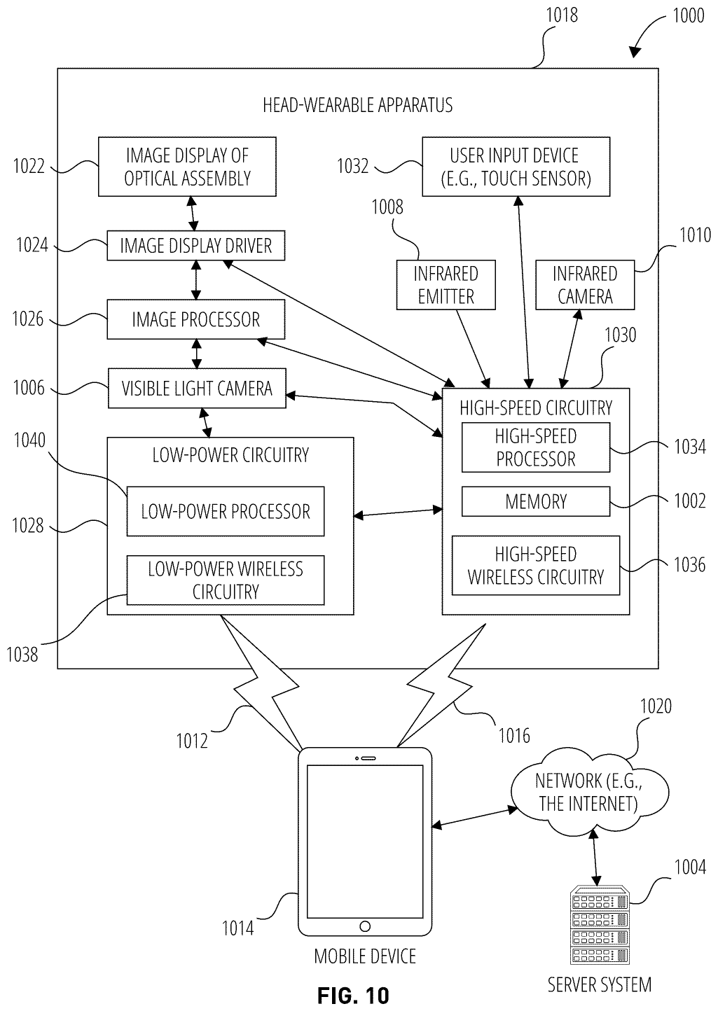

FIG. 10 illustrates a system 1000 including a head-wearable apparatus 1018 with a selector input device, according to some examples. FIG. 10 is a high-level functional block diagram of an example head-wearable apparatus 1018 communicatively coupled to a mobile device 1014 and various server systems 1004 (e.g., the interaction server system 110) via various networks 108.

The head-wearable apparatus 1018 includes one or more cameras, each of which may be, for example, a visible light camera 1006, an infrared emitter 1008, and an infrared camera 1010.

The mobile device 1014 connects with head-wearable apparatus 1018 using both a low-power wireless connection 1012 and a high-speed wireless connection 1016. The mobile device 1014 is also connected to the server system 1004 and the network 1020.

The head-wearable apparatus 1018 further includes two image displays of the image display of optical assembly 1022. The two image displays of optical assembly 1022 include one associated with the left lateral side and one associated with the right lateral side of the head-wearable apparatus 1018. The head-wearable apparatus 1018 also includes an image display driver 1024, an image processor 1026, low-power circuitry 1028, and high-speed circuitry 1030. The image display of optical assembly 1022 is for presenting images and videos, including an image that can include a graphical user interface to a user of the head-wearable apparatus 1018.

The image display driver 1024 commands and controls the image display of optical assembly 1022. The image display driver 1024 may deliver image data directly to the image display of optical assembly 1022 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 1018 includes a frame and stems (or temples) extending from a lateral side of the frame. The head-wearable apparatus 1018 further includes a user input device 1032 (e.g., touch sensor or push button), including an input surface on the head-wearable apparatus 1018. The user input device 1032 (e.g., touch sensor or push button) is to receive from the user an input selection to manipulate the graphical user interface of the presented image.

The components shown in FIG. 10 for the head-wearable apparatus 1018 are located on one or more circuit boards, for example a PCB or flexible PCB, in the rims or temples. Alternatively, or additionally, the depicted components can be located in the chunks, frames, hinges, or bridge of the head-wearable apparatus 1018. Left and right visible light cameras 1006 can include digital camera elements such as a complementary metal oxide— semiconductor (CMOS) image sensor, charge-coupled device, camera lenses, or any other respective visible or light-capturing elements that may be used to capture data, including images of scenes with unknown objects.

The head-wearable apparatus 1018 includes a memory 1002, which stores instructions to perform a subset or all of the functions described herein. The memory 1002 can also include a storage device.

As shown in FIG. 10, the high-speed circuitry 1030 includes a high-speed processor 1034, a memory 1002, and high-speed wireless circuitry 1036. In some examples, the image display driver 1024 is coupled to the high-speed circuitry 1030 and operated by the high-speed processor 1034 in order to drive the left and right image displays of the image display of optical assembly 1022. The high-speed processor 1034 may be any processor capable of managing high-speed communications and operation of any general computing system needed for the head-wearable apparatus 1018. The high-speed processor 1034 includes processing resources needed for managing high-speed data transfers on a high-speed wireless connection 1016 to a wireless local area network (WLAN) using the high-speed wireless circuitry 1036. In certain examples, the high-speed processor 1034 executes an operating system such as a LINUX operating system or other such operating system of the head-wearable apparatus 1018, and the operating system is stored in the memory 1002 for execution. In addition to any other responsibilities, the high-speed processor 1034 executing a software architecture for the head-wearable apparatus 1018 is used to manage data transfers with high-speed wireless circuitry 1036. In certain examples, the high-speed wireless circuitry 1036 is configured to implement Institute of Electrical and Electronic Engineers (IEEE) 802.11 communication standards, also referred to herein as WiFi. In some examples, other high-speed communications standards may be implemented by the high-speed wireless circuitry 1036.

The low-power wireless circuitry 1038 and the high-speed wireless circuitry 1036 of the head-wearable apparatus 1018 can include short-range transceivers (Bluetooth™) and wireless wide, local, or wide area network transceivers (e.g., cellular or WiFi). Mobile device 1014, including the transceivers communicating via the low-power wireless connection 1012 and the high-speed wireless connection 1016, may be implemented using details of the architecture of the head-wearable apparatus 1018, as can other elements of the network 1020.

The memory 1002 includes any storage device capable of storing various data and applications, including, among other things, camera data generated by the left and right visible light cameras 1006, the infrared camera 1010, and the image processor 1026, as well as images generated for display by the image display driver 1024 on the image displays of the image display of optical assembly 1022. While the memory 1002 is shown as integrated with high-speed circuitry 1030, in some examples, the memory 1002 may be an independent standalone element of the head-wearable apparatus 1018. In certain such examples, electrical routing lines may provide a connection through a chip that includes the high-speed processor 1034 from the image processor 1026 or the low-power processor 1040 to the memory 1002. In some examples, the high-speed processor 1034 may manage addressing of the memory 1002 such that the low-power processor 1040 will boot the high-speed processor 1034 any time that a read or write operation involving memory 1002 is needed.

As shown in FIG. 10, the low-power processor 1040 or high-speed processor 1034 of the head-wearable apparatus 1018 can be coupled to the camera (visible light camera 1006, infrared emitter 1008, or infrared camera 1010), the image display driver 1024, the user input device 1032 (e.g., touch sensor or push button), and the memory 1002.

The head-wearable apparatus 1018 is connected to a host computer. For example, the head-wearable apparatus 1018 is paired with the mobile device 1014 via the high-speed wireless connection 1016 or connected to the server system 1004 via the network 1020. The server system 1004 may be one or more computing devices as part of a service or network computing system, for example, that includes a processor, a memory, and network communication interface to communicate over the network 1020 with the mobile device 1014 and the head-wearable apparatus 1018.

The mobile device 1014 includes a processor and a network communication interface coupled to the processor. The network communication interface allows for communication over the network 1020, low-power wireless connection 1012, or high-speed wireless connection 1016. Mobile device 1014 can further store at least portions of the instructions for generating binaural audio content in the mobile device 1014's memory to implement the functionality described herein.

Output components of the head-wearable apparatus 1018 include visual components, such as a display such as a liquid crystal display (LCD), a plasma display panel (PDP), a light-emitting diode (LED) display, a projector, or a waveguide. The image displays of the optical assembly are driven by the image display driver 1024. The output components of the head-wearable apparatus 1018 further include acoustic components (e.g., speakers), haptic components (e.g., a vibratory motor), other signal generators, and so forth. The input components of the head-wearable apparatus 1018, the mobile device 1014, and server system 1004, such as the user input device 1032, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 1018 may also include additional peripheral device elements. Such peripheral device elements may include biometric sensors, additional sensors, or display elements integrated with the head-wearable apparatus 1018. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 1012 and high-speed wireless connection 1016 from the mobile device 1014 via the low-power wireless circuitry 1038 or high-speed wireless circuitry 1036.

Any biometric collected by the biometric components is captured and stored with only user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

Machine Architecture

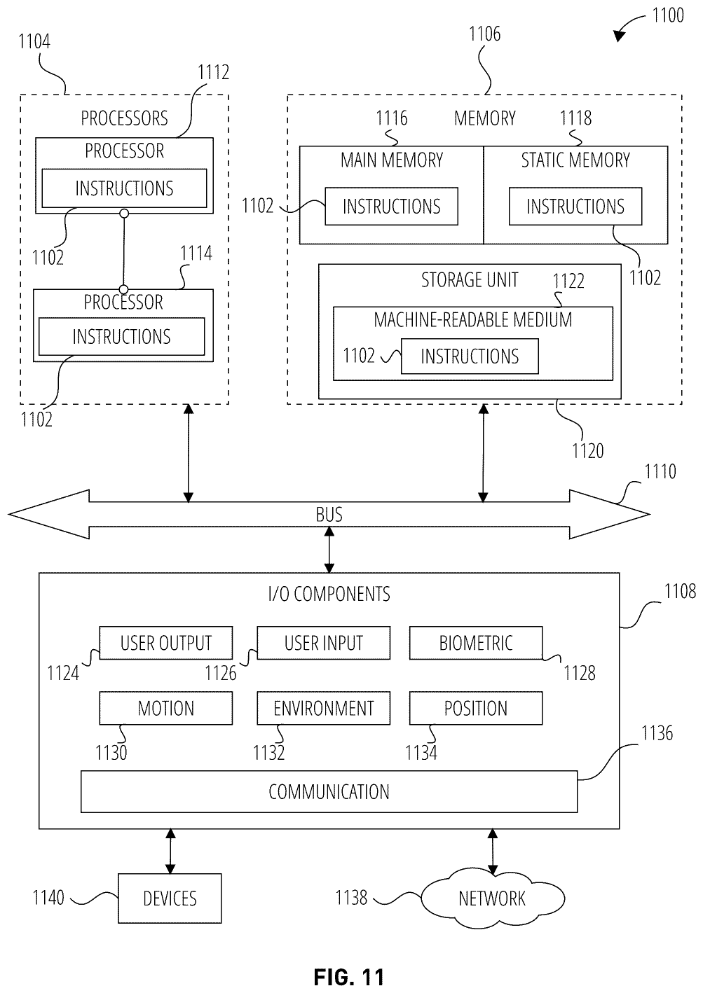

FIG. 11 is a diagrammatic representation of a machine 1100 within which instructions 1102 (e.g., software, a program, an application, an applet, an app, or other executable code) for causing the machine 1100 to perform any one or more of the methodologies discussed herein may be executed. For example, the instructions 1102 may cause the machine 1100 to execute any one or more of the methods described herein. The instructions 1102 transform the general, non-programmed machine 1100 into a particular machine 1100 programmed to carry out the described and illustrated functions in the manner described. The machine 1100 may operate as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1102, sequentially or otherwise, that specify actions to be taken by the machine 1100. Further, while a single machine 1100 is illustrated, the term “machine” shall also be taken to include a collection of machines that individually or jointly execute the instructions 1102 to perform any one or more of the methodologies discussed herein. The machine 1100, for example, may comprise the user system 102 or any one of multiple server devices forming part of the interaction server system 110. In some examples, the machine 1100 may also comprise both client and server systems, with certain operations of a particular method or algorithm being performed on the server-side and with certain operations of the particular method or algorithm being performed on the client-side.

The machine 1100 may include processors 1104, memory 1106, and input/output I/O components 1108, which may be configured to communicate with each other via a bus 1110. In an example, the processors 1104 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1112 and a processor 1114 that execute the instructions 1102. The term “processor” is intended to include multi-core processors that may comprise two or more independent processors (sometimes referred to as “cores”) that may execute instructions contemporaneously. Although FIG. 11 shows multiple processors 1104, the machine 1100 may include a single processor with a single-core, a single processor with multiple cores (e.g., a multi-core processor), multiple processors with a single core, multiple processors with multiples cores, or any combination thereof.

The memory 1106 includes a main memory 1116, a static memory 1118, and a storage unit 1120, both accessible to the processors 1104 via the bus 1110. The main memory 1106, the static memory 1118, and storage unit 1120 store the instructions 1102 embodying any one or more of the methodologies or functions described herein. The instructions 1102 may also reside, completely or partially, within the main memory 1116, within the static memory 1118, within machine-readable medium 1122 within the storage unit 1120, within at least one of the processors 1104 (e.g., within the processor's cache memory), or any suitable combination thereof, during execution thereof by the machine 1100.

The I/O components 1108 may include a wide variety of components to receive input, provide output, produce output, transmit information, exchange information, capture measurements, and so on. The specific I/O components 1108 that are included in a particular machine will depend on the type of machine. For example, portable machines such as mobile phones may include a touch input device or other such input mechanisms, while a headless server machine will likely not include such a touch input device. It will be appreciated that the I/O components 1108 may include many other components that are not shown in FIG. 11. In various examples, the I/O components 1108 may include user output components 1124 and user input components 1126. The user output components 1124 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1126 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1108 may include biometric components 1128, motion components 1130, environmental components 1132, or position components 1134, among a wide array of other components. For example, the biometric components 1128 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1130 include acceleration sensor components (e.g., accelerometer), gravitation sensor components, rotation sensor components (e.g., gyroscope).

The environmental components 1132 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple camera systems may include a wide camera, an ultra-wide camera, a telephoto camera, a macro camera, and a depth sensor, for example.

The position components 1134 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1108 further include communication components 1136 operable to couple the machine 1100 to a network 1138 or devices 1140 via respective coupling or connections. For example, the communication components 1136 may include a network interface component or another suitable device to interface with the network 1138. In further examples, the communication components 1136 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1140 may be another machine or any of a wide variety of peripheral devices (e.g., a peripheral device coupled via a USB).

Moreover, the communication components 1136 may detect identifiers or include components operable to detect identifiers. For example, the communication components 1136 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1136, such as location via Internet Protocol (IP) geolocation, location via Wi-Fi® signal triangulation, location via detecting an NFC beacon signal that may indicate a particular location, and so forth.

The various memories (e.g., main memory 1116, static memory 1118, and memory of the processors 1104) and storage unit 1120 may store one or more sets of instructions and data structures (e.g., software) embodying or used by any one or more of the methodologies or functions described herein. These instructions (e.g., the instructions 1102), when executed by processors 1104, cause various operations to implement the disclosed examples.

The instructions 1102 may be transmitted or received over the network 1138, using a transmission medium, via a network interface device (e.g., a network interface component included in the communication components 1136) and using any one of several well-known transfer protocols (e.g., hypertext transfer protocol (HTTP)). Similarly, the instructions 1102 may be transmitted or received using a transmission medium via a coupling (e.g., a peer-to-peer coupling) to the devices 1140.

Software Architecture

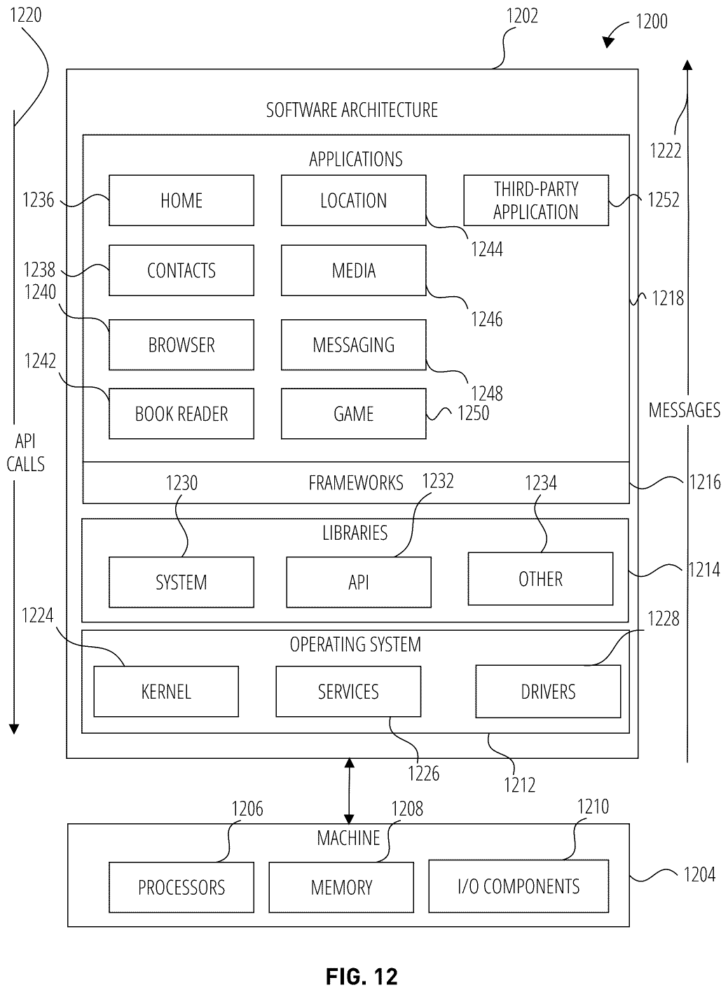

FIG. 12 is a block diagram 1200 illustrating a software architecture 1202, which can be installed on any one or more of the devices described herein. The software architecture 1202 is supported by hardware such as a machine 1204 that includes processors 1206, memory 1208, and I/O components 1210. In this example, the software architecture 1202 can be conceptualized as a stack of layers, where each layer provides a particular functionality. The software architecture 1202 includes layers such as an operating system 1212, libraries 1214, frameworks 1216, and applications 1218. Operationally, the applications 1218 invoke API calls 1220 through the software stack and receive messages 1222 in response to the API calls 1220.

The operating system 1212 manages hardware resources and provides common services. The operating system 1212 includes, for example, a kernel 1224, services 1226, and drivers 1228. The kernel 1224 acts as an abstraction layer between the hardware and the other software layers. For example, the kernel 1224 provides memory management, processor management (e.g., scheduling), component management, networking, and security settings, among other functionalities. The services 1226 can provide other common services for the other software layers. The drivers 1228 are responsible for controlling or interfacing with the underlying hardware. For instance, the drivers 1228 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1214 provide a common low-level infrastructure used by the applications 1218. The libraries 1214 can include system libraries 1230 (e.g., C standard library) that provide functions such as memory allocation functions, string manipulation functions, mathematic functions, and the like. In addition, the libraries 1214 can include API libraries 1232 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1214 can also include a wide variety of other libraries 1234 to provide many other APIs to the applications 1218.

The frameworks 1216 provide a common high-level infrastructure that is used by the applications 1218. For example, the frameworks 1216 provide various graphical user interface (GUI) functions, high-level resource management, and high-level location services. The frameworks 1216 can provide a broad spectrum of other APIs that can be used by the applications 1218, some of which may be specific to a particular operating system or platform.

In an example, the applications 1218 may include a home application 1236, a contacts application 1238, a browser application 1240, a book reader application 1242, a location application 1244, a media application 1246, a messaging application 1248, a game application 1250, and a broad assortment of other applications such as a third-party application 1252. The applications 1218 are programs that execute functions defined in the programs. Various programming languages can be employed to create one or more of the applications 1218, structured in a variety of manners, such as object-oriented programming languages (e.g., Objective-C, Java, or C++) or procedural programming languages (e.g., C or assembly language). In a specific example, the third-party application 1252 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1252 can invoke the API calls 1220 provided by the operating system 1212 to facilitate functionalities described herein.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a method comprising: detecting a determinable interaction pattern of interactions by a first user, via a user system, with a content item communicated on an interaction system by a second user, the determinable interaction pattern comprising multiple access actions with respect to the content item by the first user; and responsive to detecting the determinable interaction pattern, automatically activating an action graphical user interface element that is user selectable to enable the first user to perform an action related to the content item.

In Example 2, the subject matter of Example 1 includes, wherein the detecting of the multiple access actions comprises detecting multiple viewings of the content item by the first user using an interaction client of the interaction system.

In Example 3, the subject matter of Example 2 includes, wherein the content item comprises video content, and the detecting of the multiple viewings of the content item comprises detecting re-watching of the video content by the first user using the interaction client.

In Example 4, the subject matter of Examples 2-3 includes, wherein the content item comprises image content, and the detecting of the multiple viewings of the content item comprises detecting re-viewing of the image content by the first user using the interaction client.

In Example 5, the subject matter of Examples 1˜4 includes, wherein the content item comprises audio content, and the detecting of the multiple access actions comprises detecting re-listening to the audio content by the first user using an interaction client of the interaction system.

In Example 6, the subject matter of Examples 1-5 includes, wherein the automatic activation of the action graphical user interface element comprises visually highlighting the action graphical user interface element within a context of a viewing user interface of an interaction client of the interaction system.

In Example 7, the subject matter of Examples 1-6 includes, wherein the automatic activation of the action graphical user interface element comprises causing the action graphical user interface element to undergo a display state change within a context of a viewing user interface of an interaction client of the interaction system.

In Example 8, the subject matter of Example 7 includes, wherein the display state change comprises adjustment of a color of the action graphical user interface element.

In Example 9, the subject matter of Examples 1-8 includes, wherein the automatic activation of the action graphical user interface element comprises automatically adjusting a display state of the action graphical user interface element based on a number of times the content item has been accessed by the first user.

In Example 10, the subject matter of Examples 1-9 includes, wherein the automatic activation of the action graphical user interface element comprises causing presentation of the action graphical user interface element in association with the content item within a context of a viewing user interface of an interaction client of the interaction system, wherein the action graphical user interface element is not presented in association with the content item within the context of the viewing user interface prior to the detection of the determinable interaction pattern.

In Example 11, the subject matter of Examples 1-10 includes, detecting a selection of the action graphical user interface element; and responsive to detecting the selection, automatically invoking a function of the interaction system to enable the first user to perform the action related to the content item.

In Example 12, the subject matter of Example 11 includes, wherein the function is a reply function to enable the first user to reply to the second user, responsive to the communication of the content item on the interaction system by the second user.

In Example 13, the subject matter of Examples 11-12 includes, wherein the function is a messaging function to enable the first user to send a message to the second user, responsive to the communication of the content item on the interaction system by the second user.

In Example 14, the subject matter of Examples 1-13 includes, wherein the content item is part of a set of content items published by the second user on the interaction system, and wherein the automatic activation of the action graphical user interface element comprises automatically activating the action graphical user interface element with respect to each of the set of content items when accessed by the first user on the interaction system.

In Example 15, the subject matter of Example 14 includes, wherein the set of content items is published by the interaction system as a feed associated with the second user, the feed being accessible to the first user on account of relationship information maintained by the interaction system indicating a relationship between the first user and the second user.

In Example 16, the subject matter of Examples 1-15 includes, wherein the action graphical user interface element comprises at least one of a camera button, a text input field, or a share button.

In Example 17, the subject matter of Examples 1-16 includes, wherein the action graphical user interface element comprises a tray of user selectable elements presented within a context of a viewing user interface of an interaction client of the interaction system.

In Example 18, the subject matter of Examples 1-17 includes, wherein the detecting of the multiple access actions comprises detecting the multiple access actions within a determinable time.

Example 19 is a computing apparatus comprising: at least one processor; and at least one memory storing instructions that, when executed by the at least one processor, configure the computing apparatus to perform operations comprising: detecting a determinable interaction pattern of interactions by a first user, via a user system, with a content item communicated on an interaction system by a second user, the determinable interaction pattern comprising multiple access actions with respect to the content item by the first user; and responsive to detecting the determinable interaction pattern, automatically activating an action graphical user interface element that is user selectable to enable the first user to perform an action related to the content item.

Example 20 is a non-transitory computer-readable storage medium, the computer-readable storage medium including instructions that when executed by a computer, cause the computer to perform operations comprising: detecting a determinable interaction pattern of interactions by a first user, via a user system, with a content item communicated on an interaction system by a second user, the determinable interaction pattern comprising multiple access actions with respect to the content item by the first user; and responsive to detecting the determinable interaction pattern, automatically activating an action graphical user interface element that is user selectable to enable the first user to perform an action related to the content item.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

The various features, steps, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### Glossary

“Carrier signal” refers to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device,” or “user device,” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a manner as to encode information in the signal. The terms “transmission medium” and “signal medium” mean the same thing and may be used interchangeably in this disclosure.

“User input content” refers to any form of content that may be posted, published, shared, sent, received or interacted with by a user, e.g., using an online platform. User input content may, for example, include digital content in the form of one or more image, photo, video clip, audio clip, text, or a combination thereof. A user input content item may, in some examples, be a UGC (user-generated content) item. User input content may, for example, have an augmentation applied to it (e.g., a lens, a filter, a media overlay, or other augmentation) and may thus be an augmented reality content item. A user input content item may be generated by a user, for example, where the content item is captured by a user using a digital camera of a user device, or, for example, where the content item is created by the user by applying an augmentation to another content item. A user input content item may be user-selected, for example, where the content item is selected from a media library or file storage, or, for example, sourced from a third party or third-party device. User input content may also include partially or fully computer-generated content, e.g., content created through generative artificial intelligence. A content item may, for example, be content data, such as a picture, video or audio data (or combinations thereof).

What is claimed is:

1. A method comprising:
detecting a determinable interaction pattern of interactions by a first user, via a user system, with a content item communicated on an interaction system by a second user, the determinable interaction pattern comprising multiple access actions with respect to the content item by the first user; and
responsive to detecting the determinable interaction pattern, automatically activating an action graphical user interface element that is user selectable to enable the first user to perform an action related to the content item.

2. The method of claim 1, wherein the detecting of the multiple access actions comprises detecting multiple viewings of the content item by the first user using an interaction client of the interaction system.

3. The method of claim 2, wherein the content item comprises video content, and the detecting of the multiple viewings of the content item comprises detecting re-watching of the video content by the first user using the interaction client.

4. The method of claim 2, wherein the content item comprises image content, and the detecting of the multiple viewings of the content item comprises detecting re-viewing of the image content by the first user using the interaction client.

5. The method of claim 1, wherein the content item comprises audio content, and the detecting of the multiple access actions comprises detecting re-listening to the audio content by the first user using an interaction client of the interaction system.

6. The method of claim 1, wherein the automatic activation of the action graphical user interface element comprises visually highlighting the action graphical user interface element within a context of a viewing user interface of an interaction client of the interaction system.

7. The method of claim 1, wherein the automatic activation of the action graphical user interface element comprises causing the action graphical user interface element to undergo a display state change within a context of a viewing user interface of an interaction client of the interaction system.

8. The method of claim 7, wherein the display state change comprises adjustment of a color of the action graphical user interface element.

9. The method of claim 1, wherein the automatic activation of the action graphical user interface element comprises automatically adjusting a display state of the action graphical user interface element based on a number of times the content item has been accessed by the first user.

10. The method of claim 1, wherein the automatic activation of the action graphical user interface element comprises causing presentation of the action graphical user interface element in association with the content item within a context of a viewing user interface of an interaction client of the interaction system, wherein the action graphical user interface element is not presented in association with the content item within the context of the viewing user interface prior to the detection of the determinable interaction pattern.

11. The method of claim 1, comprising:
detecting a selection of the action graphical user interface element; and
responsive to detecting the selection, automatically invoking a function of the interaction system to enable the first user to perform the action related to the content item.

12. The method of claim 11, wherein the function is a reply function to enable the first user to reply to the second user, responsive to the communication of the content item on the interaction system by the second user.

13. The method of claim 11, wherein the function is a messaging function to enable the first user to send a message to the second user, responsive to the communication of the content item on the interaction system by the second user.

14. The method of claim 1, wherein the content item is part of a set of content items published by the second user on the interaction system, and wherein the automatic activation of the action graphical user interface element comprises automatically activating the action graphical user interface element with respect to each of the set of content items when accessed by the first user on the interaction system.

15. The method of claim 14, wherein the set of content items is published by the interaction system as a feed associated with the second user, the feed being accessible to the first user on account of relationship information maintained by the interaction system indicating a relationship between the first user and the second user.

16. The method of claim 1, wherein the action graphical user interface element comprises at least one of a camera button, a text input field, or a share button.

17. The method of claim 1, wherein the action graphical user interface element comprises a tray of user selectable elements presented within a context of a viewing user interface of an interaction client of the interaction system.

18. The method of claim 1, wherein the detecting of the multiple access actions comprises detecting the multiple access actions within a determinable time.

19. A computing apparatus comprising:
at least one processor; and
at least one memory storing instructions that, when executed by the at least one processor, configure the computing apparatus to perform operations comprising:
detecting a determinable interaction pattern of interactions by a first user, via a user system, with a content item communicated on an interaction system by a second user, the determinable interaction pattern comprising multiple access actions with respect to the content item by the first user; and
responsive to detecting the determinable interaction pattern, automatically activating an action graphical user interface element that is user selectable to enable the first user to perform an action related to the content item.

20. A non-transitory computer-readable storage medium, the computer-readable storage medium including instructions that when executed by a computer, cause the computer to perform operations comprising:
detecting a determinable interaction pattern of interactions by a first user, via a user system, with a content item communicated on an interaction system by a second user, the determinable interaction pattern comprising multiple access actions with respect to the content item by the first user; and
responsive to detecting the determinable interaction pattern, automatically activating an action graphical user interface element that is user selectable to enable the first user to perform an action related to the content item.
